(19) United States
(12) Patent Application Publication
(10) Pub. No.: US 2026/0184117 A1
(43) Pub. Date: Jul. 2, 2026

(54) PNEUMATIC TIRE

(71) Applicant: Toyo Tire Corporation, Itami-shi (JP)

(72) Inventors: Hiroki Tabuchi, Itami-shi (JP); Kumiko Takahashi, Itami-shi (JP)

(73) Assignee: Toyo Tire Corporation, Itami-shi (JP)

(21) Appl. No.: 19/426,524

(22) Filed: Dec. 19, 2025

(30) Foreign Application Priority Data
Dec. 26, 2024 (JP) 2024-230499
Dec. 26, 2024 (JP) 2024-230518
Dec. 26, 2024 (JP) 2024-230541

(51) Int. Cl. B60C 13/04; B60C 9/20; B60C 11/00; B60C 11/03; B60C 15/00

(52) U.S. Cl. CPC B60C 13/04; B60C 9/20; B60C 11/0008; B60C 11/005; B60C 11/033; B60C 15/0036; B60C 2009/2016; B60C 2009/2019; B60C 2009/2022; B60C 2011/0033; B60C 2011/0355; B60C 2013/045

(57) ABSTRACT

A pneumatic tire according to an embodiment includes a different color rubber portion provided on a side wall and made of rubber having a lower carbon black content than rubber constituting the side wall, a length along a tire outer surface from an interface between a rim strip rubber and a lower side wall rubber to an interface between the lower side wall rubber and the different color rubber portion is 3% or more and 12% or less of a tire cross-sectional height H, and in a tire axially cross section in a standard rim assembling and internal pressure uninflated state, a tire thickness from a tire inner surface to a tire outer surface is smaller at a tire axial center than at a ground contact end.

### BACKGROUND OF THE INVENTION

### 1. Field of the Invention

The present invention relates to a pneumatic tire.

### 2. Description of Related Art

A side wall is well-known in which letters, symbols, and pattern portions, such as lines or figures continuously or discontinuously provided in a tire circumferential direction, are made of a different color rubber composition, such as white rubber, and are provided on the side wall to improve the visibility and design of a tire. This type of the side wall is formed, for example, in such a manner that a predetermined portion of unvulcanized black rubber forming the side wall is divided in a radial direction, different color rubber is disposed during the division, and then a black cover rubber layer is provided on the different color rubber to form a green tire, the formed green tire is then vulcanized in a predetermined mold, and then a part of the cover rubber layer is ground away to expose the different color rubber as a pattern portion.

As a technique related to a side wall provided with different color rubber, for example, JP6798876B discloses that a volume of different color rubber is set to 60% or more and 70% or less of a volume of black rubber to prevent a black residue phenomenon in which the black rubber is partially exposed in a pattern portion.

### SUMMARY OF THE INVENTION

In the tire including the side wall provided with the different color rubber as described in JP6798876B, an interface between the different color rubber and the black rubber is present, and thus the number of interfaces is increased as compared to a tire including only a black side wall, and the durability tends to be reduced.

In consideration of the above points, an object of an embodiment of the invention is to provide a pneumatic tire that can exhibit excellent durability while providing different color rubber on a side wall.

The invention includes embodiments to be described below.

A pneumatic tire including: a pair of bead portions spaced apart in a tire axial direction; a pair of side walls provided on a tire radially outer side from the pair of bead portions; a tread provided between the pair of side walls; a carcass ply extending from the tread through the side walls and locked at the bead portions; a different color rubber portion provided on a tire axially outer side of the carcass ply in the side walls, and made of rubber having a lower carbon black content than rubber constituting the side walls; and a rim strip rubber provided on a tire axially outer side of the bead portions and including a portion in contact with a wheel rim, in which each of the side walls includes an upper side wall rubber provided on a tire radially outer side of the different color rubber portion, and a lower side wall rubber provided between the different color rubber portion and the rim strip rubber, a length A along a tire outer surface from an interface between the rim strip rubber and the lower side wall rubber to an interface between the lower side wall rubber and the different color rubber portion is 3% or more and 12% or less of a tire cross-sectional height H, and in a tire axially cross section in a standard rim assembling and internal pressure uninflated state, a tire thickness from a tire inner surface to the tire outer surface is smaller at a tire axial center than at a ground contact end.

According to the embodiment of the invention, separation can be prevented from occurring and durability can be improved in the pneumatic tire with the different color rubber disposed on the side walls.

### BRIEF DESCRIPTION OF THE DRAWINGS

FIG. 1 is a cross-sectional view of a pneumatic tire according to a first embodiment of the invention;

FIG. 2 is a developed view showing a tread pattern of the pneumatic tire in FIG. 1;

FIG. 3 is a developed view showing a tread pattern of a pneumatic tire according to Modification 1 of the invention;

FIG. 4 is a half cross-sectional view of a pneumatic tire according to Modification 2 of the invention;

FIG. 5 is a half cross-sectional view of a pneumatic tire according to Modification 3 of the invention; and

FIG. 6 is a half cross-sectional view of a pneumatic tire according to Modification 4 of the invention.

### DESCRIPTION OF EMBODIMENTS

Hereinafter, an embodiment will be described with reference to the drawings.

Note that in the drawings, a reference numeral CL indicates a tire equatorial plane and corresponds to a tire axial center. Here, a tire radial direction is a direction perpendicular to a tire rotation axis, and is indicated by a reference numeral RD in the drawing. A tire radially inner side is a direction toward the tire rotation axis, and a tire radially outer side is a direction away from the tire rotation axis. A tire axial direction is a direction parallel to the tire rotation axis, and is indicated by a reference numeral WD in the drawings. A tire axially inner side is a direction toward the tire axial center CL, and a tire axially outer side is a direction away from the tire axial center CL. A tire circumferential direction is a direction in a circle centered on the tire rotation axis, and is indicated by an arrow CD in the drawing.

In the drawings, a reference numeral E indicates a ground contact end of a tire. The ground contact ends E are at outermost positions of a ground contact surface in the tire axial direction WD. The ground contact surface refers to a surface of a tread portion which comes into contact with a road when the tire is placed perpendicular to a flat road while the tire is assembled to a standard rim and inflated to a standard internal pressure, and is subjected to a standard load. A tire cross-sectional height H refers to a length in the tire radial direction from an inner diameter surface to an outer diameter surface of the unloaded pneumatic tire 1 mounted on a standard rim and inflated to a standard internal pressure.

The standard rim is a rim defined, by a specification on which tires are based, for each tire in a standard system including the specification, and for example, refers to a standard rim in a case of JATMA, and a “measuring rim” in a case of TRA and ETRTO.

A standard load is a load defined, by a specification on which tires are based, for each tire in a specification system including the standard, and refers to a maximum load capacity in the case of JATMA, a maximum value listed in the table above in the case of TRA, and a “load capacity” in the case of ETRTO.

A standard internal pressure refers to a “maximum air pressure” in the JATMA specification, a “maximum value” listed in a “TIRE LOAD LIMITS AT VARIOUS COLD INFLATION PRESSURES” in the TRA specification, or an “INFLATION PRESSURE” in the ETRTO specification.

In the present specification, “overlapping” includes not only a case where tire components such as bead fillers, carcass plies, belt plies, and a tread rubber are in direct contact with each other and overlap each other, but also a case where the tire components overlap each other via another component interposed therebetween.

### (1) Basic Structure of Pneumatic Tire 1

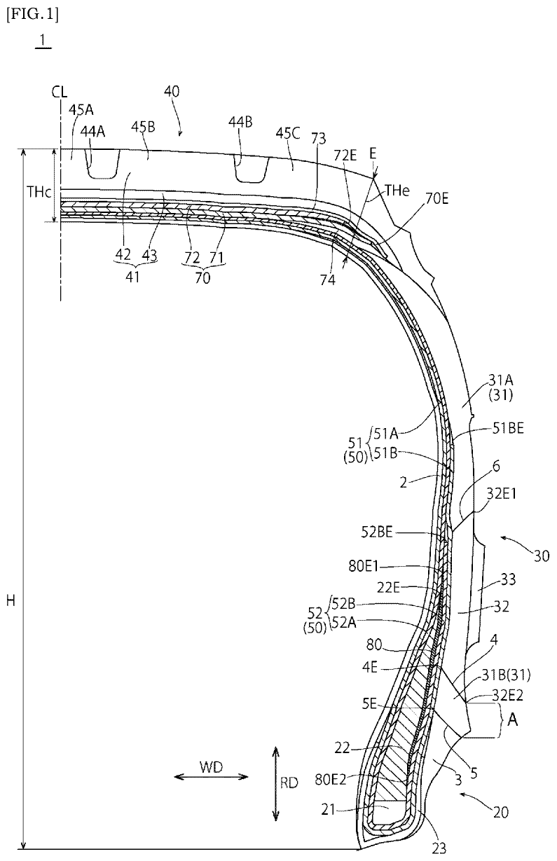

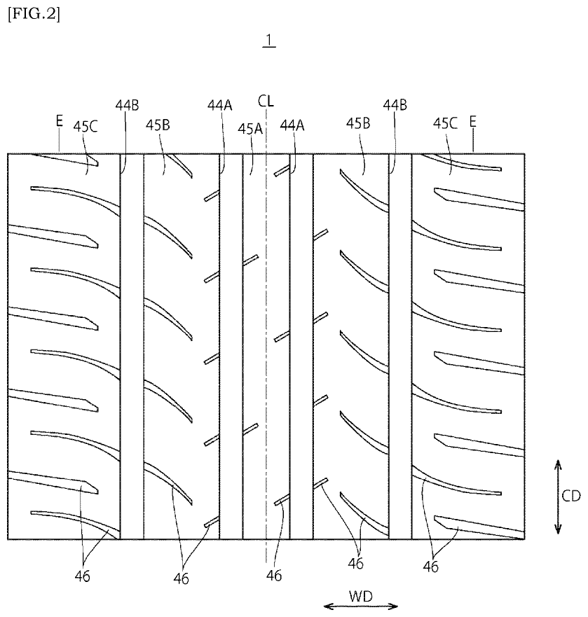

A pneumatic tire 1 according to an embodiment shown in FIGS. 1 and 2 includes a pair of left and right bead portions 20, a pair of left and right side walls 30 extending outward in the tire radial direction from the bead portions 20, and a tread 40 connecting tire radially outer ends of the side walls 30 and constituting a ground contact surface.

A ring-shaped bead core 21 is embedded in each of the pair of bead portions 20. A bead filler 22 tapering toward the tire radially outer side and made of hard rubber is provided on a tire radially outer side of the bead core 21. A rim strip rubber 3 is provided on an outer side in the tire axial direction WD of the bead filler 22 of each of the bead portions 20. The rim strip rubber 3 is a rubber member that forms an outer surface of the bead portion 20 and comes into contact with a wheel rim (not shown) on which the pneumatic tire 1 is mounted. A reference numeral 23 denotes a chafer provided at the bead portion 20. The chafer 23 is provided on the outside of the carcass 50 provided at the bead portion 20 to wrap around the bead core 21 and the bead filler 22. The chafer 23 may use a fiber chafer containing organic fibers such as nylon fibers, a rubber chafer, or the like.

The pneumatic tire 1 includes a carcass 50 that spans toroidally between the pair of bead portions 20. The carcass 50 extends from the tread 40 through the side walls 30 and is locked by being turned up from the tire axially inner side to the tire axially outer side around the bead cores 21 in the bead portions 20. An inner liner 2 is provided on an inner surface of the carcass 50 as an air permeation-resistant rubber layer.

A side reinforcing layer 80 is provided on the outer side in the tire axial direction WD of the bead filler 22 of each of the bead portions 20. The rim strip rubber 3 is provided on a tire outer side (that is, outer side in the tire axial direction WD) of the carcass 50 in each of the bead portions 20. A side wall rubber 31 and a different color rubber portion 32 are provided on the tire outer side of the carcass 50 in the side walls 30. A belt 70 is provided on an outer side in the tire radial direction RD of the carcass 50 in the tread 40. A belt reinforcing layer 73 and a tread rubber 41 are laminated on an outer side in the tire radial direction RD of the belt 70.

### (2) Tread 40

The tread rubber 41 is provided at the tread 40. The tread rubber 41 has a two-layer structure including a cap rubber layer 42 having a tread surface in contact with the road, and a base rubber layer 43 disposed on an inner side in the tire radial direction RD of the cap rubber layer 42. The tread rubber 41 covers an outer end in the tire radial direction RD of the side wall rubber 31 provided on the side wall 30. Note that the tread rubber 41 and the side wall rubber 31 may be disposed such that the outer end in the tire radial direction RD of the side wall rubber 31 covers the end in the tire axial direction WD of the tread rubber 41 from the outside.

A plurality of main grooves 44A and 44B extending along the tire circumferential direction CD are spaced apart in the tire axial direction WD and are formed in the cap rubber layer 42. In this example, a pair of center main grooves 44A are provided on both sides of the tire axial center CL, and a pair of shoulder main grooves 44B are disposed on outer sides of the pair of center main grooves 44A.

A plurality of land portions 45A, 45B, and 45C are defined in the tire axial direction WD by the plurality of main grooves 44A and 44B and are formed in the cap rubber layer 42. That is, the cap rubber layer 42 is provided with the center land portion 45A sandwiched between the pair of center main grooves 44A and 44A, a pair of left and right middle land portions 45B each sandwiched between the center main groove 44A and the shoulder main groove 44B, and a pair of left and right shoulder land portions 45C each formed between the shoulder main groove 44B and the ground contact end E. Lateral grooves 46 extending in a direction intersecting with the tire circumferential direction CD are provided in each of the land portions 45A, 45B, and 45C.

The base rubber layer 43 is implemented by a rubber layer provided on the tire radially outer side of the belt reinforcing layer 73 and having a substantially uniform rubber thickness. The base rubber layer 43 may use a rubber composition having the same rubber hardness as that of a rubber composition constituting the cap rubber layer 42. The base rubber layer 43 may use a rubber composition having lower rubber hardness than that of the rubber composition constituting the cap rubber layer 42.

The cap rubber layer 42 and the base rubber layer 43 constituting the tread rubber 41 preferably use a rubber composition having rubber hardness in a range of 52 to 68.

In the present specification, the rubber hardness is measured at 23° C. using a Type A durometer in accordance with JIS K6253.

The belt 70 is provided at an inner side in the tire radial direction RD of the base rubber layer 43. The belt 70 includes at least two belt plies. Each of the belt plies includes a belt cord arranged at an inclination angle of 10 degrees or more and 35 degrees or less, preferably 22 degrees or more and 28 degrees or less with respect to the tire circumferential direction CD. The at least two belt plies are overlapped such that the belt cords cross each other. In this example, the belt has a two-layer structure including a first belt ply 71 disposed on an inner side in the tire radial direction RD and a second belt ply 72 disposed on an outer circumferential side of the first belt ply 71. The first belt ply 71 is a widest belt having a largest width, and an outer end in the tire axial direction WD of the first belt ply 71 corresponds to a tire axially outer end 70E of the belt 70. A steel cord or an organic fiber cord having high tension is used as the belt cord.

In this example, the belt reinforcing layer 73 is provided on the outer side in the tire radial direction RD of the belt 70, that is, between the belt 70 and the tread rubber 41. The belt reinforcing layer 73 is implemented by a cap ply having cords extending substantially parallel to the tire circumferential direction CD.

Furthermore, an underbelt rubber layer 74, which does not include a cord reinforcing material such as an organic fiber or steel cord, is provided between an end in the tire axial direction WD of the first belt ply 71 and the carcass 50.

In the pneumatic tire 1 of the present embodiment, in a cross section in the tire axial direction WD while the tire is assembled to a standard rim and not inflated with an internal pressure (standard rim assembling and internal pressure uninflated state), a tire thickness THc at the center in the tire axial direction WD is smaller than a tire thickness THe at the ground contact end E.

Here, the tire thickness THc at the tire axial center CL is a tire thickness taken along a normal line to a tire surface profile at the tire axial center CL, and the tire thickness THe at the ground contact end E is a tire thickness taken along a normal line to the tire surface profile at the ground contact end E. The tire surface profile is a contour line of an outer surface of the tread 40 excluding the main grooves 44A and 44B, and is typically defined by a curve formed by smoothly connecting a plurality of arcs.

That is, as shown in FIGS. 1 and 2, when grooves such as the main grooves 44A or lateral grooves 46 are not provided on the tire axial center CL, the tire thickness THc at the tire axial center CL is a length in a normal direction of the outer surface of the tread 40 from an outer surface of the cap rubber layer 42 that forms a tire outer surface to an inner surface of the inner liner 2 that forms a tire inner surface. When a groove is provided on the tire axial center CL, the tire thickness THc is a length in the normal direction of the outer surface of the tread 40 from an opening surface of the groove to the inner surface of the inner liner 2.

When grooves such as the lateral grooves 46 are not provided at the ground contact end E, the tire thickness THe at the ground contact end E is a length in the normal direction of the outer surface of the tread 40 from the outer surface of the cap rubber layer 42 to the inner surface of the inner liner 2. When a groove is provided at the ground contact end E, the tire thickness THe is a length in the normal direction of the outer surface of the tread 40 from the opening surface of the groove to the inner surface of the inner liner 2.

### (3) Side Wall 30

The side wall rubber 31 and the different color rubber portion 32 are provided on the side walls 30. The outer end in the tire radial direction RD of the side wall rubber 31 is joined to the end in the tire axial direction WD of the tread rubber 41, and the inner end in the tire radial direction RD thereof is joined to the outer end in the tire radial direction RD of the rim strip rubber 3. Similar to the tread rubber 41 and the rim strip rubber 3, the side wall rubber 31 uses a black rubber composition (black rubber) containing carbon black as a reinforcing filler.

In the present embodiment, the different color rubber portion 32 is made of white rubber, but the different color rubber portion 32 may be any color rubber as long as rubber contains carbon black less than that of the side wall rubber 31. The white rubber composition constituting the different color rubber portion 32 can use any well-known white rubber composition commonly used for this application, and is not particularly limited.

For example, the different color rubber portion 32 does not contain carbon black as a reinforcing filler, but is made of a rubber composition containing fillers other than carbon black (that is, non-carbon black fillers), such as silica, talc, or clay. The side wall rubber 31 is made of a rubber composition that is softer (that is, lower in hardness) and has lower rigidity than that of the rim strip rubber 3. The different color rubber portion 32 can use a rubber composition that is softer (that is, lower in hardness) and has lower rigidity than that of the black rubber composition containing carbon black that constitutes the side wall rubber 31. As an example, rubber hardness of the rim strip rubber 3 may be 60 to 85, rubber hardness of the side wall rubber 31 may be 50 to 70, and rubber hardness of the different color rubber portion 32 may be 40 to 70.

The different color rubber portion 32 is disposed in a ring shape along the circumferential direction on a part of the side wall 30 in a radial direction. A part of an outer surface of the different color rubber portion 32 is covered by a cover rubber layer (not shown) made of black rubber of the same color as the side wall rubber 31, and an exposed portion of the different color rubber portion 32 that is not covered serves as a different color display portion 33.

The different color display portion 33 displays a predetermined design, letter, symbol, pattern, or line or figure arranged continuously or discontinuously in the tire circumferential direction on the tire outer surface in a color different from the side wall rubber. This different color display portion 33 may protrude from the tire outer surface. The different color display portion 33 may be provided in a ring shape that is continuous in the tire circumferential direction CD, or may be provided discontinuously along the circumferential direction depending on the shape of the display.

As shown in FIG. 1, the different color rubber portion 32 is provided from the tire outer surface to a first turned-up portion 51B of a first carcass ply 51 in the tire axial direction WD in a region at the inner side in the tire radial direction RD of the side wall 30. By providing the different color rubber portion 32 in this manner, the different color rubber portion 32 radially divides the black side wall rubber 31 in the vicinity of the center in the tire radial direction RD. Accordingly, the side wall rubber 31 includes an upper side wall rubber 31A formed on the outer side in the tire radial direction RD of the different color rubber portion 32, and a lower side wall rubber 31B formed on the inner side in the tire radial direction RD of the different color rubber portion 32.

A tire radially outer end 32E1 of the different color rubber portion 32 may be positioned at a tire radially outer side of a tire radially outer end (tip end) 22E of the bead filler 22, and a tire radially inner end 32E2 of the different color rubber portion 32 may be positioned at the tire radially inner side of the tip end 22E of the bead filler 22. That is, the tip end 22E of the bead filler 22 may overlap the different color rubber portion 32 in the tire axial direction WD via the first turned-up portion 51B and a second turned-up portion 52B of the carcass 50. In the present embodiment, the tip end 22E of the bead filler 22 extends toward the tire radially outer side to a position overlapping the different color display portion 33 when viewed from the tire axial direction WD.

In the present embodiment, both ends of the different color rubber portion 32 in the tire radial direction are inclined to be narrower toward the tire axially inner side, and a length in the radial direction of the tire outer surface of the different color rubber portion 32 is set longer than a length in the radial direction of the tire inner surface thereof.

A cross-sectional shape of the different color rubber portion 32 may be formed in various shapes. For example, both ends of the different color rubber portion 32 in the tire radial direction may be inclined to be wider toward the tire axially inner side. Both ends of the different color rubber portion 32 in the tire radial direction may be arranged approximately parallel to the tire axial direction. One end in the tire radial direction of the different color rubber portion 32 may be inclined with respect to the tire axial direction, and the other end in the tire radial direction may be arranged approximately parallel to the tire axial direction.

In the present embodiment, an interface 5 between the lower side wall rubber 31B and the rim strip rubber 3 is inclined toward the inner side in the tire radial direction RD as the interface 5 extends toward the outer side in the tire axial direction WD, and is inclined approximately parallel to the same direction as an interface 4 between the different color rubber portion 32 and the lower side wall rubber 31B.

In the present embodiment, the tire radially inner end 32E2 of the different color rubber portion 32 is positioned at an inner side in the tire radial direction RD of a tire radially outer end of the rim strip rubber 3, and overlaps a tire radially outer end of the rim strip rubber 3 in the tire axial direction via the lower side wall rubber 31B.

As shown in FIG. 1, the different color rubber portion 32 is provided at a position where a length A along the tire outer surface from the interface 4 between the different color rubber portion 32 and the lower side wall rubber 31B to the interface 5 between the lower side wall rubber 31B and the rim strip rubber 3 is 3% or more and 12% or less of the tire cross-sectional height H. Preferably, the length A is 6.0% or more and 10.0% or less of the tire cross-sectional height H.

By setting a ratio of the length A along the tire outer surface from the interface 4 to the interface 5 to the tire cross-sectional height H to 3% or more, it is possible to ensure a distance from the rim strip rubber 3 around the bead portion 20, where strain energy is likely to concentrate when a load is applied, to the interface 4 of the different color rubber portion 32, the separation can be prevented from occurring, and the durability can be improved, and by setting the ratio of the length A to the tire cross-sectional height H to 4.5% or more, the durability can be further improved.

In addition, by setting this ratio to 12% or less, the different color rubber portion 32 can be disposed at a conspicuous position on the side wall 30, the different color rubber can be exposed without exposing the black side wall rubber on display portions of designs and letters, thereby preventing a deterioration in an appearance quality, and by setting this ratio to 10% or less, the different color rubber can be exposed without exposing the side wall rubber over a wide range in the tire radial direction.

### (4) Carcass 50

The carcass 50 includes two carcass plies, that is, the first carcass ply 51 and a second carcass ply 52, in which constituent cords extending obliquely with respect to the tire circumferential direction CD are included and are laminated in directions opposite to each other. The carcass plies 51 and 52 are formed into sheets obtained by coating a plurality of parallel-aligned cords with rubber. Examples of the plurality of cords in the carcass plies 51 and 52 include organic fiber cords such as polyester fiber, rayon fiber, aramid fiber, or nylon fiber, or steel cords.

The first carcass ply 51 includes a first main portion 51A that extends from the tread 40 through the side wall 30 to the bead core 21 of the bead portion 20, and the first turned-up portion 51B that extends from the first main portion 51A and is turned up around the bead core 21 from the inner side to the outer side in the tire axial direction WD.

The first main portion 51A passes the inner side in the tire axial direction WD of the bead filler 22 and reaches an inner side in the tire radial direction RD of the bead core 21. The first turned-up portion 51B is wound up to the outer side in the tire radial direction RD from the inner side in the tire radial direction RD of the bead core 21 by passing the outer side in the tire axial direction WD of the bead filler 22.

The second carcass ply 52 includes a second main portion 52A that extends from the tread 40 through the side wall 30 to the bead core 21 of the bead portion 20, and the second turned-up portion 52B that extends from the second main portion 52A and is turned up around the bead core 21 from the inner side to the outer side in the tire axial direction WD.

The second main portion 52A is disposed on the tire radially outer side of the first main portion 51A in the tread 40. The second main portion 52A extends along an outer surface of the first main portion 51A toward the bead portion 20, passes between the first main portion 51A and the bead filler 22, and reaches the inner side in the tire radial direction RD of the bead core 21. The second turned-up portion 52B is wound up to the outer side in the tire radial direction RD from the inner side in the tire radial direction RD of the bead core 21 by passing between the bead filler 22 and the first turned-up portion 51B.

The first turned-up portion 51B of the first carcass ply 51 terminates at a position on the outer side in the tire radial direction RD of the different color rubber portion 32 provided on the side wall 30. That is, a first turned-up end 51BE, which is an outer end in the tire radial direction RD of the first turned-up portion 51B, is positioned at the outer side in the tire radial direction RD of the tire radially outer end 32E1 of the different color rubber portion 32, and overlaps the upper side wall rubber 31A in the tire axial direction.

The second turned-up portion 52B of the second carcass ply 52 extends toward the outer side in the tire radial direction RD of the lower side wall rubber 31B, and terminates at the inner side in the tire radial direction RD of the upper side wall rubber 31A. More specifically, a second turned-up end 52BE, which is an outer end in the tire radial direction RD of the second turned-up portion 52B, is positioned at the outer side in the tire radial direction RD of the tire radially inner end 32E2 of the different color rubber portion 32, is positioned at the inner side in the tire radial direction RD of the tire radially outer end 32E1 of the different color rubber portion 32, and overlaps the different color rubber portion 32 in the tire axial direction. The second turned-up end 52BE of the second turned-up portion 52B is preferably positioned on the outer side in the tire radial direction RD of the tip end 22E of the bead filler 22, and is preferably disposed at a position 15 mm or more away from the tip end 22E of the bead filler 22 toward the outer side in the tire radial direction RD.

### (5) Side Reinforcing Layer 80

The side reinforcing layer 80 is a rubber layer formed by arranging a plurality of reinforcing cords made of steel cords or organic fiber cords in parallel at predetermined intervals and being coated with rubber. The side reinforcing layer 80 is provided between the bead filler 22 and the second turned-up portion 52B. A tire radially inner end 80E2 of the side reinforcing layer 80 is disposed on the outer side in the tire radial direction RD of the bead core 21 and at a position overlapping the rim strip rubber 3 in the tire axial direction WD. The side reinforcing layer 80 extends outward in the tire radial direction RD along the outer side in the tire axial direction WD of the bead filler 22, and is disposed up to a position at the tire radially outer side of the bead filler 22.

That is, the tire radially inner end 80E2 of the side reinforcing layer 80 is positioned on the outer side in the tire radial direction RD of an outer end in the tire radial direction RD of the bead core 21, and is positioned on a tire radially inner side of a tire axially inner end 5E of the interface 5 between the lower side wall rubber 31B and the rim strip rubber 3.

The tire radially inner end 80E2 of the side reinforcing layer 80 may be disposed on the tire radially inner side of a tire radially outer end 23E of the chafer 23 provided on the tire axially outer side of the bead filler 22, and the side reinforcing layer 80 and the chafer 23 overlap in the tire axial direction WD, or may be disposed on the tire radially outer side of the tire radially outer end 23E of the chafer 23.

A tire radially outer end 80E1 of the side reinforcing layer 80 is preferably positioned on the outer side in the tire radial direction RD of the tip end 22E of the bead filler 22, and is preferably disposed at a position 5 mm or more and 10 mm or less away from the tip end 22E of the bead filler 22 toward the outer side in the tire radial direction RD. From a viewpoint of increasing the rigidity and improving the durability of the bead portion 20 and the side wall 30, the second turned-up end 52BE of the second turned-up portion 52B is preferably positioned on the outer side in the tire radial direction RD of the tire radially outer end 80E1 of the side reinforcing layer 80.

The tire radially outer end 80E1 of the side reinforcing layer 80 may be provided at a position overlapping the different color rubber portion 32 in the tire axial direction WD, or provided at a position overlapping the different color display portion 33 of the different color rubber portion 32 in the tire axial direction WD, or provided at a position overlapping the upper side wall rubber 31A in the tire axial direction WD.

### (6) Effects

In the pneumatic tire 1 of the present embodiment, the length A along the tire outer surface from the interface 5 between the rim strip rubber 3 and the lower side wall rubber 31B to the interface 4 between the lower side wall rubber 31B and the different color rubber portion 32 is 3% or more and 12% or less of the tire cross-sectional height H, and since a distance from the rim strip rubber 3 in the vicinity of the bead portion 20 where the strain energy is likely to concentrate when a load is applied is ensured, the stress acting on the interface 4 between the different color rubber portion 32 and the lower side wall rubber 31B can be reduced, the separation at the interface can be prevented from occurring, and the durability can be improved.

In the pneumatic tire 1 of the present embodiment, in a tire axially cross section in a standard rim assembling and internal pressure uninflated state, a tire thickness from the tire inner surface to the tire outer surface is smaller at a tire axial center than at a ground contact end, and thus the tread 40 is more likely to flex and deform. Accordingly, flexure of the entire tire is more easily dispersed to the tread 40, so that a flexural deformation that occurs on the tire radially inner side of the bead portion 20 and the side wall 30 can be prevented, the separation at the interface 5 between the different color rubber portion 32 and the side wall rubber 31 can be prevented from occurring, and the durability can be improved.

In the present embodiment, by setting an angle of the belt cord provided on the belt 70 with respect to the tire circumferential direction CD to 22 degrees or more and 28 degrees or less, the tread 40 can be constrained in the tire radial direction while allowing a moderate deformation, and the flexural deformation that occurs on the tire radially inner side of the bead portion 20 and the side wall 30 can be prevented without impairing tire running performance, the separation at the interface 5 between the different color rubber portion 32 and the side wall rubber 31 can be prevented from occurring, and the durability can be improved.

By adjusting the belt angle of the belt cord with respect to the tire circumferential direction CD within the above range, a ground contact pressure of the tire is uniform, and strain is dispersed to the entire tire, thereby preventing the flexural deformation in the side wall 30 and the bead portion 20.

In the present embodiment, by disposing the tip end 22E of the bead filler 22 to overlap the different color rubber portion 32 in the tire axial direction WD, the interface between the different color rubber portion 32 and the side wall rubber 31 can be reinforced, the separation at the interface of the different color rubber portion 32 can be prevented from occurring, and the durability can be improved.

In particular, as in the present embodiment, when the second turned-up end 52BE is disposed on the tire radially outer side of the tip end 22E of the bead filler 22, the bead filler 22 is reinforced by the tension of the second carcass ply 52, so that the rigidity of the entire side wall 30 can be increased, and the separation at the interface of the different color rubber portion 32 can be further prevented from occurring. In this case, by disposing the second turned-up end 52BE at the position 15 mm or more away from the tip end 22E of the bead filler 22 toward the outer side in the tire radial direction RD, air is less likely to enter between the bead filler 22 and the second carcass ply 52 during tire manufacturing, and molding defects can be prevented.

In the pneumatic tire 1 of the present embodiment, the first turned-up portion 51B of the first carcass ply 51 is disposed on the tire radially outer side of the different color rubber portion 32, and the second turned-up end 52BE of the second carcass ply 52 overlaps the different color rubber portion 32 in the tire axial direction, and thus, the rigidity of the side wall 30 in the vicinity of the different color rubber portion 32 can be increased, separation at an interface 6 between the different color rubber portion 32 and the upper side wall rubber 31A and at the interface 4 between the different color rubber portion 32 and the lower side wall rubber 31B can be prevented from occurring, and the durability can be improved.

In the present embodiment, the first turned-up portion 51B and the second turned-up portion 52B are provided such that the second turned-up end 52BE is disposed to be accommodated in the different color rubber portion 32 in the tire radial direction RD while the second turned-up end 52BE is wrapped from the tire axially outer side by the first turned-up portion 51B extending toward the tire radially outer side of the different color rubber portion 32, and thus a high reinforcing effect is achieved while a length in the tire radial direction of the second turned-up portion 52B is short. As a result, it is possible to achieve both reduced rolling resistance through weight reduction and improved durability through increased rigidity.

In the pneumatic tire 1 of the present embodiment, the side reinforcing layer 80 having the above configuration is provided between the bead filler 22 and the second turned-up portion 52B, and thus, the rigidity in the vicinity of the rim strip rubber 3 and the lower side wall rubber 31B where the strain is likely to concentrate when a load is applied can be increased, the separation at the interface 4 between the different color rubber portion 32 and the lower side wall rubber 31B can be prevented from occurring, and the durability can be improved.

As in the pneumatic tire 1 of the present embodiment, by disposing the tire radially outer end 80E1 of the side reinforcing layer 80 on the tire radially outer side of the tip end 22E of the bead filler 22, the side reinforcing layer 80 exhibits a high reinforcing effect, and since component ends of the side reinforcing layer 80 and the bead filler 22 do not overlap each other, air is less likely to enter between the components during the tire manufacturing, and molding defects can be prevented.

### (7) Modifications

Next, modifications will be described. Various modifications can be made to the above embodiments without departing from the gist of the invention. Although a plurality of modifications will be described below, any one of the plurality of modifications described below may be applied to the above embodiment, or any two or more of the modifications described below may be applied in combination. In addition to the modifications below, various omissions, substitutions, and changes can be made without departing from the gist of the invention. In the drawings showing the modifications, the same components as those in the above embodiment are denoted by the same reference numerals as those in the above embodiment.

### (7-1) Modification 1

In the present modification, a void ratio of each of regions is set such that a central void ratio, which is a void ratio of a central region TC of the tread 40, is greater than a shoulder void ratio, which is a void ratio of a shoulder region TS.

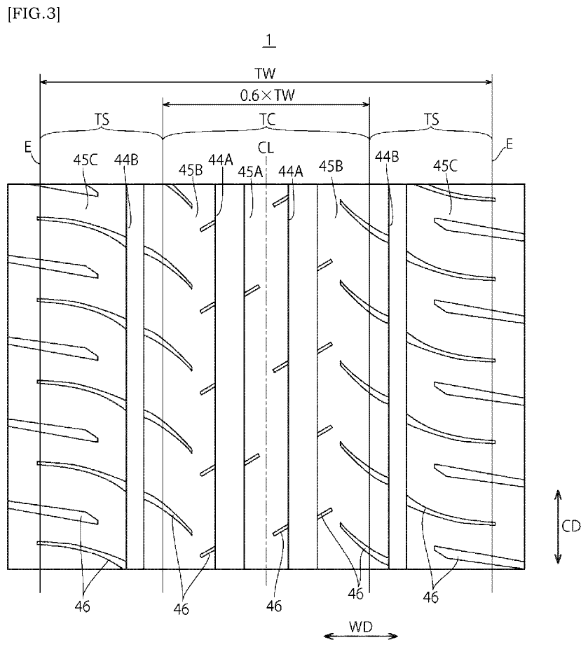

Specifically, as shown in FIG. 3, if a length in the tire axial direction WD of the region sandwiched between the ground contact ends E of the tread 40, that is, a distance between the ground contact ends E on both sides in the tire axial direction WD, is defined as a ground contact width TW, the central region TC refers to a region in a range of 60% of the ground contact width TW centered on the tire axial center CL. The shoulder region TS is a region extending from the central region TC to each of the ground contact ends E on both sides in the tire axial direction WD.

The central void ratio refers to a ratio of an opening area of recess portions provided in the central region TC to an area of the central region TC, that is, the central void ratio is an area ratio of a non-ground contact portion to the central region TC. The shoulder void ratio refers to a ratio of an opening area of the recess portions provided in the shoulder region TS to an area of the shoulder region TS, that is, the shoulder void ratio is an area ratio of the non-ground contact portion to the shoulder region TS.

Here, an area of the non-ground contact portion is a sum of opening areas of the main grooves 44A and 44B and the lateral grooves 46. Note that if narrow grooves with a groove width of 1.5 mm or less, called sipes, are provided in the central region TC or the shoulder region TS, opening areas of these narrow grooves are also included in the area of the non-ground contact portion.

In the present modification, the central void ratio is greater than the shoulder void ratio, and thus the tread 40 is more likely to flex and deform. Accordingly, the strain that is likely to concentrate in the side wall 30 when a load is applied is dispersed to the central region of the tread 40, and the flexural deformation that occurs on the tire radially inner side of the bead portion 20 and the side wall 30 can be prevented, and the separation at the interface 5 between the different color rubber portion 32 and the side wall rubber 31 can be prevented from occurring.

### (7-2) Modification 2

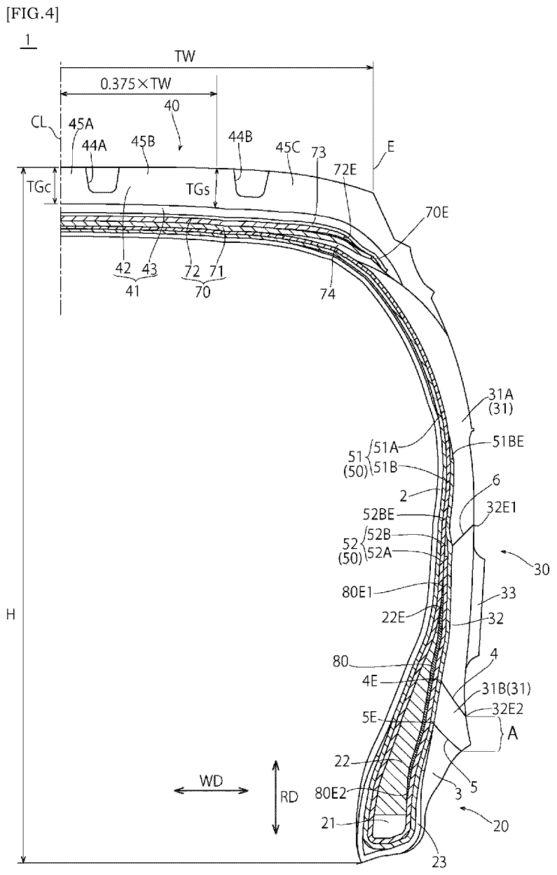

As shown in FIG. 4, in Modification 2, a rubber thickness TGc of the cap rubber layer 42 of the tread 40 at the tire axial center CL is set smaller than a rubber thickness TGs of the cap rubber layer 42 at a position 37.5% of the ground contact width TW away from the tire axial center CL toward the outer side in the tire axial direction WD. In the present modification, the base rubber layer 43 uses a rubber composition having lower rubber hardness than that of the rubber composition constituting the cap rubber layer 42.

In the present modification, a thickness of the cap rubber layer 42 is set smaller at the tire axial center CL than that at a position away from the tire axial center CL toward the outer side in the tire axial direction WD, and thus the tread 40 is more likely to flex and deform. Accordingly, the strain that is likely to concentrate in the side wall 30 when a load is applied is dispersed to the tread 40, and the flexural deformation that occurs in the side wall 30 can be prevented, and the separation at the interface 5 between the different color rubber portion 32 and the side wall rubber 31 can be prevented from occurring.

### (7-3) Modification 3

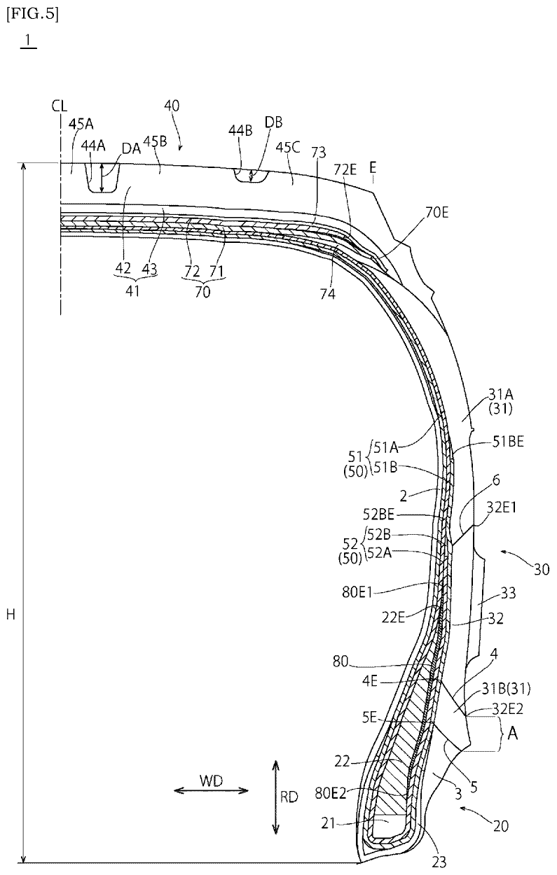

As shown in FIG. 5, in Modification 3, a groove depth DA of the center main groove 44A is larger than a groove depth DB of the shoulder main groove 44B. By setting the groove depths of the center main groove 44A and the shoulder main grooves 44B in this way, the tread 40 is more likely to flex and deform. Accordingly, the strain that is likely to concentrate in the side wall 30 when a load is applied is dispersed to the central region of the tread 40, so that the flexural deformation that occurs on the tire radially inner side of the bead portion 20 and the side wall 30 can be prevented, and the separation at the interface 5 between the different color rubber portion 32 and the side wall rubber 31 can be prevented from occurring.

FIG. 5 illustrates a case where two center main grooves 44A and two shoulder main grooves 44B are provided, and in other cases where the tread 40 has three or more main grooves, such as a case where one center main groove is provided at the tire axial center CL of the tread 40 and shoulder main grooves are provided on both sides of the center main groove in the tire axial direction, thereby providing three main grooves in the tread 40, or a case where middle main grooves and shoulder main grooves are provided on both sides of one center main groove in the tire axial direction, thereby providing five main grooves in the tread 40, by setting the groove depth of the center main groove larger than the groove depth of the shoulder main groove, the strain that is likely to concentrate in the side wall 30 when a load is applied is dispersed to a central region of the tread, the flexural deformation in the side wall 30 is prevented, and the separation at the interface between the different color rubber portion 32 and the side wall rubber 31 can be prevented from occurring.

### (7-4) Modification 4

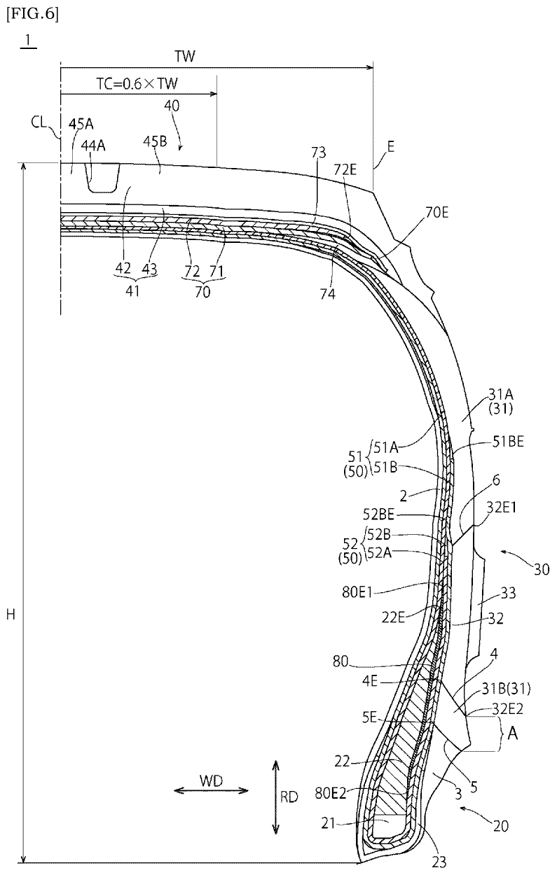

As shown in FIG. 6, in Modification 4, when in a region sandwiched by the ground contact ends E of the tread 40, a range of 60% of a ground contact width TW centered on the tire axial center CL is defined as a central region TC, and each of regions from both sides in the tire axial direction WD of the central region TC to the ground contact ends E is defined as a shoulder region TS, the main groove 44A extending in the tire circumferential direction CD is provided in the central region TC, and the main groove extending in the tire circumferential direction CD is not provided in the shoulder region TS.

In the present modification, the load applied to the pneumatic tire 1 is more likely to be dispersed to the tread 40, so that the flexure deformation that occurs on the tire radially inner side of the bead portion 20 and the side wall 30 can be prevented, and the separation at the interface 5 between the different color rubber portion 32 and the side wall rubber 31 can be prevented from occurring.

### (8) Examples

Hereinafter, Examples will be shown, but the invention is not limited to these Examples.

In order to show the effects of the above embodiment, pneumatic tires of Examples 1 to 3 and Comparative Examples 1 and 2 were produced as prototypes.

The pneumatic tires of Examples 1 to 3 and Comparative Examples 1 and 2 were radial tires having a cross-sectional shape shown in FIG. 1, having the tread pattern shown in FIG. 2, and having a tire size of 195/80R15, and the lengths A along the tire outer surface from the interface 5 between the rim strip rubber 3 and the lower side wall rubber 31B to the interface 4 between the lower side wall rubber 31B and the different color rubber portion 32 were different. The length A, the tire cross-sectional height H, and the ratio of the length A to the tire cross-sectional height H of each of the pneumatic tires of Examples 1 to 3 and Comparative Examples 1 and 2 are as shown in Table 1.

In all examples, the cross-sectional height was 156 mm, the tire thickness THc at the tire axial center in the tire axially cross section in a standard rim assembling and internal pressure uninflated state was 16.4 mm, the tire thickness THe at the ground contact end E was 17.4 mm, and the configurations other than the length A were the same.

General durability was evaluated for each of these tires. Evaluation methods are as follows.
Durability: a durability performance test was conducted in accordance with a method specified in JIS D4230. If the separation or other failure was not confirmed after completing a test stage 3, the tire was continued to be loaded, and a mileage until the failure was confirmed was measured, and was expressed as an index with a value for Example 1 set to 100. A higher index indicated better durability performance.
Appearance quality: each of the obtained pneumatic tires was visually inspected to confirm whether black rubber penetrated the different color display portion, and it was determined as “A” if the black rubber did not penetrate the different color display portion, and it was determined as “B” if the black rubber penetrated the different color display portion.

TABLE 1

| | Compar- | | | | Compar- |
|---|---|---|---|---|---|
| | ative | | | | ative |
| | Exam- | Exam- | Exam- | Exam- | Exam- |
| | ple 1 | ple 1 | ple 2 | ple 3 | ple 2 |
| Length A (mm) | 1 | 7 | 12 | 18 | 21 |
| Tire cross- | 156 | 156 | 156 | 156 | 156 |
| sectional height | | | | | |
| H (mm) | | | | | |
| Ratio (A/H) (%) | 0.6 | 4.5 | 7.7 | 11.5 | 13.5 |
| Durability (%) | 78 | 100 | 111 | 133 | 144 |
| Appearance | A | A | A | A | B |
| quality | | | | | |

The results are shown in Table 1, and in Examples 1 to 3, the separation was unlikely to occur at the interface 4 between the different color rubber portion 32 and the lower side wall rubber 31B, and excellent durability was exhibited. In Examples 1 to 3, the black rubber did not penetrate the different color display portion, and the appearance quality was also excellent.

On the other hand, in Comparative Example 1, the durability was inferior to that of Examples 1 to 3. In Comparative Example 2, the black rubber penetrated the different color display portion, resulting in poor appearance quality.

### REFERENCE SIGNS LIST

1: pneumatic tire
2: inner liner
3: rim strip rubber
20: bead portion
21: bead core
22: bead filler
30: side wall
31: side wall rubber
32: different color rubber portion
33: different color display portion
40: tread
41: tread rubber
42: cap rubber layer
43: base rubber layer
44A: center main groove
44B: shoulder main groove
45A: center land portion
45B: middle land portion
45C: shoulder land portion
46: lateral groove
47: annular protrusion
50: carcass
51: first carcass ply
51A: first main portion
51B: first turned-up portion
52: second carcass ply
52A: second main portion
52B: second turned-up portion
70: belt
71: first belt ply
72: second belt ply

What is claimed is:

1. A pneumatic tire comprising:
a pair of bead portions spaced apart in a tire axial direction;
a pair of side walls provided on a tire radially outer side from the pair of bead portions;
a tread provided between the pair of side walls;
a carcass ply extending from the tread through the side walls and locked at the bead portions;
a different color rubber portion provided on a tire axially outer side of the carcass ply in the side walls, and made of rubber having a lower carbon black content than rubber constituting the side walls; and
a rim strip rubber provided on a tire axially outer side of the bead portions and including a portion in contact with a wheel rim, wherein
each of the side walls includes an upper side wall rubber provided on a tire radially outer side of the different color rubber portion, and a lower side wall rubber provided between the different color rubber portion and the rim strip rubber,
a length along a tire outer surface from an interface between the rim strip rubber and the lower side wall rubber to an interface between the lower side wall rubber and the different color rubber portion is 3% or more and 12% or less of a tire cross-sectional height, and
in a tire axially cross section in a standard rim assembling and internal pressure uninflated state, a tire thickness from a tire inner surface to the tire outer surface is smaller at a tire axial center than at a ground contact end.

2. The pneumatic tire according to claim 1, wherein
in a region sandwiched by ground contact ends of the tread, a range of 60% of a ground contact width centered on a tire axial center is defined as a central region, and a tire axially outer side of the central region is defined as a shoulder region, a ratio of an opening area of a recess portion provided in the central region to an area of the central region is defined as a central void ratio, and a ratio of an opening area of a recess portion provided in the shoulder region to an area of the shoulder region is defined as a shoulder void ratio, and in this case, the central void ratio is larger than the shoulder void ratio.

3. The pneumatic tire according to claim 1, wherein
the tread includes a belt including a plurality of cords covered with rubber, and a tread rubber provided on a tire radially outer side of the belt, and an inclination angle of each of the cords with respect to a tire circumferential direction is 22 degrees or more and 28 degrees or less.

4. The pneumatic tire according to claim 1, wherein
the tread includes a belt including a plurality of cords covered with rubber, and a tread rubber provided on a tire radially outer side of the belt, and rubber hardness of the tread rubber is 52 or more and 68 or less.

5. The pneumatic tire according to claim 1, wherein
each of the bead portions includes a bead core and a bead filler provided on a tire radially outer side of the bead core, and
a tire radially outer end of the bead filler overlaps the different color rubber portion in the tire axial direction.

6. The pneumatic tire according to claim 1, wherein
the tread includes a belt including a plurality of cords covered with rubber, and a tread rubber provided on a tire radially outer side of the belt,
the tread rubber includes a cap rubber layer on which a tread surface is formed, and a base rubber layer provided on a tire radially inner side of the cap rubber layer and having lower rubber hardness than the cap rubber layer, and
a rubber thickness of the cap rubber layer at the tire axial center is smaller than a rubber thickness of the cap rubber layer at a position 37.5% of a ground contact width away from the tire axial center toward a tire axially outer side.

7. The pneumatic tire according to claim 1, wherein
the tread has at least three main grooves extending in the tire circumferential direction, including at least one center main groove and a pair of shoulder main grooves positioned on both sides of the center main groove in a tire axial direction, and
a groove depth of the center main groove is greater than groove depths of the shoulder main grooves.

8. The pneumatic tire according to claim 1, wherein
when in a region sandwiched by the ground contact ends of the tread, a range of 60% of a ground contact width centered on the tire axial center is defined as a central region, and a tire axially outer side of the central region is defined as a shoulder region,
a main groove extending in the tire circumferential direction is provided in the central region, and the main groove extending in the tire circumferential direction is not provided in the shoulder region.

9. The pneumatic tire according to claim 1, wherein
each of the bead portions includes a bead core, and a bead filler provided on a tire radially outer side of the bead core,
the carcass ply includes
a first carcass ply including a first main portion extending from the tread through the side walls to the bead cores, and a first turned-up portion extending from the first main portion and turned up around the bead cores from a tire axially inner side to a tire axially outer side; and
a second carcass ply including a second main portion disposed on a tire radially outer side of the first main portion in the tread and extending from the tread through the side walls to the bead cores, and a second turned-up portion extending from the second main portion and turned up around the bead cores from the tire axially inner side to the tire axially outer side,
the different color rubber portion is provided on the tire axially outer side of the first carcass ply in the side walls, and
a tire radially outer end of the first turned-up portion is disposed on the tire radially outer side of the different color rubber portion, and a tire radially outer end of the second turned-up portion overlaps the different color rubber portion in the tire axial direction.

10. The pneumatic tire according to claim 1, wherein
each of the bead portions includes a bead core, and a bead filler provided on a tire radially outer side of the bead core,
the carcass ply includes
a first carcass ply including a first main portion extending from the tread through the side walls to the bead cores, and a first turned-up portion extending from the first main portion and turned up around the bead cores from a tire axially inner side to a tire axially outer side; and
a second carcass ply including a second main portion disposed on a tire radially outer side of the first main portion in the tread and extending from the tread through the side walls to the bead cores, and a second turned-up portion extending from the second main portion and turned up around the bead cores from the tire axially inner side to the tire axially outer side,
the different color rubber portion is provided on the tire axially outer side of the first carcass ply in the side walls, and
a tire radially outer end of the bead filler overlaps the different color rubber portion in the tire axial direction.

11. The pneumatic tire according to claim 10, wherein
a tire radially outer end of the second turned-up portion is disposed on a tire radially outer side of the tire radially outer end of the bead filler.

12. The pneumatic tire according to claim 1, wherein
each of the bead portions includes a bead core, and a bead filler provided on a tire radially outer side of the bead core,
a side reinforcing layer provided between the bead filler and the turned-up portion of the carcass ply and including a reinforcing cord is provided, and
the side reinforcing layer is provided at a region from a position at a tire radially inner side of a tire axially inner end of the interface between the rim strip rubber and the lower side wall rubber to a position at a tire radially outer side of a tire axially inner end of the interface between the lower side wall rubber and the different color rubber portion.

13. The pneumatic tire according to claim 12, wherein
a tire radially outer end of the side reinforcing layer is disposed on a tire radially outer side of a tire radially outer end of the bead filler.

14. The pneumatic tire according to claim 12, wherein
a tire radially inner end of the side reinforcing layer is disposed on the tire radially outer side of the bead core.

15. The pneumatic tire according to claim 12, wherein
the carcass ply includes
a first carcass ply including a first main portion provided between the pair of bead portions, and a first turned-up portion extending from the first main portion and turned up around the bead cores from a tire axially inner side to a tire axially outer side; and
a second carcass ply including a second main portion disposed on a tire radially outer side of the first main portion in the tread and provided between the pair of bead portions, and a second turned-up portion extending from the second main portion and turned up around the bead cores from the tire axially inner side to the tire axially outer side, and
a tire radially outer end of the first turned-up portion is disposed on the tire radially outer side of the different color rubber portion, and a tire radially outer end of the second turned-up portion overlaps the different color rubber portion in the tire axial direction.

16. The pneumatic tire according to claim 12, wherein
a tire radially outer end of the bead filler overlaps the different color rubber portion in the tire axial direction.
